(19) United States
(12) Patent Application Publication
(10) Pub. No.: US 2017/0124498 A1
(43) Pub. Date: May 4, 2017

(54) Sell in Advance of Caregiving Services or Personal Care Services or Non skilled Care Services/Coming Care

(71) Applicant: Ali Reza Khodavardad, Woodland Hills, CA (US)

(72) Inventor: Ali Reza Khodavardad, Woodland Hills, CA (US)

(21) Appl. No.: 14/929,287

(22) Filed: Oct. 31, 2015

(51) Int. Cl. G06Q 10/06

(52) U.S. Cl. CPC G06Q 10/06311

(57) ABSTRACT

Coming Care is a new model of business to sell in advance of personal care services or caregiving services and guarantee providing these services whenever customers need at the same purchased price. By statistic there is no doubt to need of personal care in the future. This model of business with compare of time value of money, compounding inflation rate, and increase of minimum wage in the last hundred years, invented value proposition for customers, pathway of distribution, and financial sustainability for Coming Care business that sell in advance personal care hours or caregiving services. This method of business provides a peace of mind for people who need personal care and their family and friends who want to be their caregiver and will solve the issues with unpaid family caregiving. Coming Care will create thousands of secured future jobs per year by changing money to personal care hours and deposit in member accounts.

### CROSS-REFERENCE TO RELATED APPLICATIONS

This application is a non-provisional of and claims the benefit of the filing date of Provisional Application 62/073,016, filed on Oct. 31, 2014.

### BACKGROUND OF THE INVENTION

The present invention is in the technical field of home care services. More particularly, the present invention is in the field of caregiving services. More particularly, the present invention is in the field of personal care services (ADL & IADL).

Care is a global need without geographic or demographic boundaries. At some point, every person and every family will have care needs, be it for seniors, disabled persons, persons with chronic health condition, children, homes and even pets.

“There are only four kinds of people in this world:

Those who have been caregivers,

Those who are currently caregivers,

Those who will be caregivers,

Those who will need caregivers.”
Former First Lady Rosalyn Carter

According to Administration on Aging, the older population, persons 65 years or older numbered 39.6 million in 2009 (the latest year for which data is available). They represented 12.9% of the U.S. population, about one in every eight Americans. By 2030, there will be about 72.1 million older persons, more than twice their number in 2000. People 65+ represented 12.4% of the population in the year 2000 but are expected to grow to be 19% of the population by 2030.

As the 78 million baby boomers born between 1946 and 1964 in the United States approach retirement, they will continue to shape society. Despite their fierce social and personal independence, it's likely that many boomers will rely on others in their later years of life, especially for long-term health care, or services that offer assistance with daily activities such as bathing, walking, eating, dressing, grooming, personal hygiene, mobility and transfer, incontinence care, meal preparation, companionship, assistance with prescribed exercise, medication management, using telephone and computer, housekeeping, driving and shopping.

When you need personal care, there are two types of cost, financial cost and emotional cost. In addition to financial costs of care, there is also an emotional cost on family and friends as they struggle to support and assist a loved one who needs care. While there are different health insurances that pay for skilled care, only Long Term Care Insurance and some State and Community programs may pay for non-skilled personal care. Medicare and Medicaid don't pay for personal care/caregivers. Source of pay for personal care are mostly out of pocket and Long Term Care Insurance.

As you see all or most of the people especially elderly need some type of personal care during their life and most of the time they have to pay out of pocket for these services.

Coming Care is a new model of business to sell in advance of personal care services and guarantee providing these services whenever customers need at same purchased price. Why do the people buy personal care in advance? The answer to this question is the base of Coming Care idea. Before answering to this question, we need to know about time value of money and time value of working hours.

Time Value of Money: One of the most fundamental concepts in finance is that money has a “time value.” That is to say that money in hand today is worth more than money that is expected to be received in the future. The reason is straightforward:

A dollar that you receive today can be invested such that you will have more than a dollar at some future time. This leads to the saying that we often use to summarize the concept of time value of money:

“A dollar today is worth more than a dollar tomorrow.”

For this reason, banks pay interest on saving deposit to cover inflation or depreciation of money. According to www.inflationrate.com the average annual inflation during last 100 years (1913-2013) was about 3.22%, and cumulative compounding rate of inflation was 2300-2400%. In other words, worth of dollar decreased to 1/24 in last hundred years. At the same time (last 100 years) minimum wage increased 62 times or cumulative rate for minimum wage in California was 6200% (It was $0.16/hour in California at 1916 and would be $10.00/hour in 2016).

So we can summarize: “One-hour work today worth less than one-hour work tomorrow”

In other words, minimum wage increased almost 2.6 times of depreciation of dollar or the speed of increase in minimum wage is almost 2.6 times of decrease worth of dollar. If we could buy personal care hours now to use it in the future is more conscious than saving money and gets minimum interest to use that saving to buy personal care hours in the future.

For example: If you had $100.00 in 1916 and bought personal care hour at minimum wage $0.16/hour, you could buy 625 hours. If you put $100.00 in a saving account or investment and have been grown with compounding interest of 3.22%, you will have $2400.00 at 2016, and can buy 240 personal care hours at minimum wage $10.00/hour. In other words, the speed of increase in minimum wage is 2.6 more than average of compounding interest you achieved.

Coming Care is a new model of business for future personal care that give this opportunity to buy personal care (caregiving hours) today and use it in the future. Coming Care model of business change money to hours and deposit in customer accounts to use it at any time they need. The personal care hours in coming care account never expire and even can transfer or donate (as a coming care gift or prepaid card to family, friends, relatives, and even poor people who need personal care). Coming care model has tax benefit (When saving or invest money you have to pay tax on your earning, but deposit hours let you save on tax). Coming care card (CCC) is in your wallet like other debit cards, and you can pay for personal care or even transfer your hours to family, friends or any loved one who take care of you as a caregiver.

### SUMMARY OF INVENTION

Coming Care is a new model of business for future personal care that give this opportunity to buy personal care (caregiving hours) in advance and use it in future.

Coming Care is a peace of mind for future personal care, is a model to deposit personal care hours for future use, and remove emotional and financial cost from shoulder of your family when you need personal care.

According to Caregiving in the U.S. 2015 that is a joint research study between the National Alliance for Caregiving and AARP, there is nearly 44 million family caregivers in the U.S. (nearly 20% of the U.S. adult population) who provide important societal and financial contributions toward maintaining the well-being of those they care for. This comprehensive research has showed estimated prevalence of caregiving as follow:
1. An estimated 43.5 million adults in the United States have provided unpaid care to an adult or a child
2. Approximately 34.2 million Americans have provided unpaid care to an adult age 50 or older
3. A large majority of caregivers provide care for a relative (85%), with 49 percent caring for a parent or parent-in-law and one in 10 provides care for a spouse.
4. Three in five care recipients have a long-term physical condition (59%), more than a third have a short-term physical condition (35%), and a quarter have a memory problem (26%). Many care recipients have more than one ongoing problem or illness (37%).
5. On average, caregivers spend 24.4 hours a week providing care to their loved one. Nearly one-quarter provide 41 or more hours of care a week (23%). Caregiving is particularly time-intensive for those caring for a spouse/partner (44.6 hours a week).
6. In addition to ADLs and IADLs, family caregivers are increasingly performing tasks that nurses typically perform. Known now as “medical/nursing tasks,” these skilled activities include injections, tube feedings, catheter and colostomy care, and many other complex care responsibilities.
7. When asked if they had a choice in taking on the responsibility to provide care for their loved one, half of caregivers self-reported they had no choice in taking on their caregiving responsibilities.
8. About stress and strain of caregiving, half of caregivers feel their health is excellent or very good (48%), while 17 percent say it is fair or poor. The longer a caregiver has been providing care, the more likely she or he is to report fair or poor health. When asked about the impact that caregiving has had on their health, 22 percent of caregivers feel their health has gotten worse as a result of caregiving.
9. About impact of caregiving on work, six in 10 caregivers report being employed at some point in the past year while caregiving. Among them, 56 percent worked full time, and on average, they worked 34.7 hours a week. When it becomes difficult to balance caregiving with work, or if the demands of work come into conflict with one's caregiving responsibilities, some caregivers make changes to their work situation. Six in 10 caregivers report having to make a workplace accommodation as a result of caregiving, such as cutting back on their working hours, taking a leave of absence, receiving a warning about performance or attendance, or other such impacts. Higher-hour caregivers are more likely to report experiencing nearly all of these work impacts.

In summary, unpaid family caregiving is an activity that knows no bounds, it cuts across all ages, genders, race/ethnicities, and relationship types. Caregiving experiences can be relatively easy to manage; they can also be challenging and stressful.

According to AARP new report, family caregivers in the U.S. provided 37 billion hours of care that worth an estimated $470 billion to their parents, spouses, partners, and other adult loved ones in 2013. Our population is rapidly aging, while the number of available family caregivers in younger generations is diminishing. As Americans live longer and have fewer children, fewer family members will be available for older adults to rely on for everybody help in the future. The ratio of potential family caregivers to the growing number of older people has already begun a steep decline. In 2010, there were 7.2 potential family caregivers for every person age 80 and older. By 2030, that ratio will fall sharply to 4 to 1, and is projected to drop further to 3 to 1 in 2050.

Coming Care is a revolutionary method of business that with in advance selling of personal care hours and guarantee to use service in the future at same purchased price, can resolve many of personal care and caregiving problems in U.S. and world. Coming Care is not a type of insurance because in all type of insurance there is uncertainty to use service in future and this is the base of insurance industry (a lot of people buy insurance and only a few people can use it). At Coming Care system, you are the boss to use your purchased hours, but in all type of insurance, insurance company make the final decision about your claim. But in Coming Care there is no uncertainty to use or even transfer of personal care hours, and purchased hours never expired. Coming care card (CCC) is in your wallet like other debit cards, and you can pay or even transfer your hours to family, friends or any loved one who take care of you as a caregiver.

Coming Care change money to caregiving hours and save in an account to use in the future, so will create caregiver jobs for the future. What does that mean?

For example: If Coming Care sold 100,000, personal care hours in advance, indeed will create 12,500, days full time job. In other example if Coming Care have 3000,000, members who bought 50 hours/year on average or 4 hours/month, this model of business will create 150,000,000, hours caregiving jobs or 18,750,000, days full time jobs or 75,000, jobs/year.

Benefits of Coming Care for government and States would be clear because of decrease cost of paying for personal caregiving care for qualified people.

Coming care services are transferable and never expire. Personal care hours can transfer like funds from one account to others, just like transfer funds in banking system. In real world many families, friends, and relatives like to take care of loved one who needs personal care, but the challenge is, they need job to spend their life. (As showed in caregiving in U.S. 2015)

With Coming Care system both of them have peace of mind. When you are member of coming care and have hours in your account, your friend, family, or relative can register as your caregiver and get paid or if they want transfer your hours to their self-coming care account.

With Coming Care Model of business, personal care services to others can save in your account to use in future. The personal care hours are transferable form one account to another account, from parents to kids, grandparents to parents or grandchildren, nephew, niece and so on . . . .

For example, if grandfather have 1000 hours in his Coming Care account and his grandson register to be his caregiver and provide 100 hours' personal care for him. The grandson has two option, can choose get paid by Coming Care system or open an account with Coming Care platform and transfer 100 hours to himself account.

The preferred embodiment of the present invention is directed to a method of providing a system to buy personal care hours in advance to use in future when there is a need at same purchased price. Coming Care model of business with compare of time value of money, compounding inflation rate, and increase of minimal wage has showed, it's more conscious to buy personal care hours in advance to use in the future in compare with saving money to buy personal care hours in the future.

In another embodiment of present invention is directed to a method of business that provide a peace of mind for people who need personal care and their family and friends who want to be their caregiver. With Coming Care Card, everybody has a debit card in the wallet to pay home care agencies, independent caregivers, family or friends, who provide them personal care.

Another embodiment of present invention is directed to reimburse by CCC or transfer of personal care hours to the account of family or friends who take care of you as a caregiver. This model of business will solve the issue with unpaid family caregiving.

One important aspect of present invention is directed to a method of creating secured future jobs by changing money to personal care hours and deposit in member accounts. In Coming Care system there is no uncertainty for future use of service and ultimate delivery of service will happen.

### BRIEF DESCRIPTION OF DRAWINGS

FIG. 1 is a perspective view of Coming Care processing

### DETAILED DESCRIPTION OF THE INVENTION

Coming Care is a new model of business to sell in advance of personal care services and guarantee providing these services whenever customers need at the same purchased price. By statistic there is no doubt to need of personal care in the future. This model of business with compare of time value of money and minimum wage, invented value proposition for customers, pathway of distribution, and financial sustainability for Coming Care business that sell in advance personal care hours.

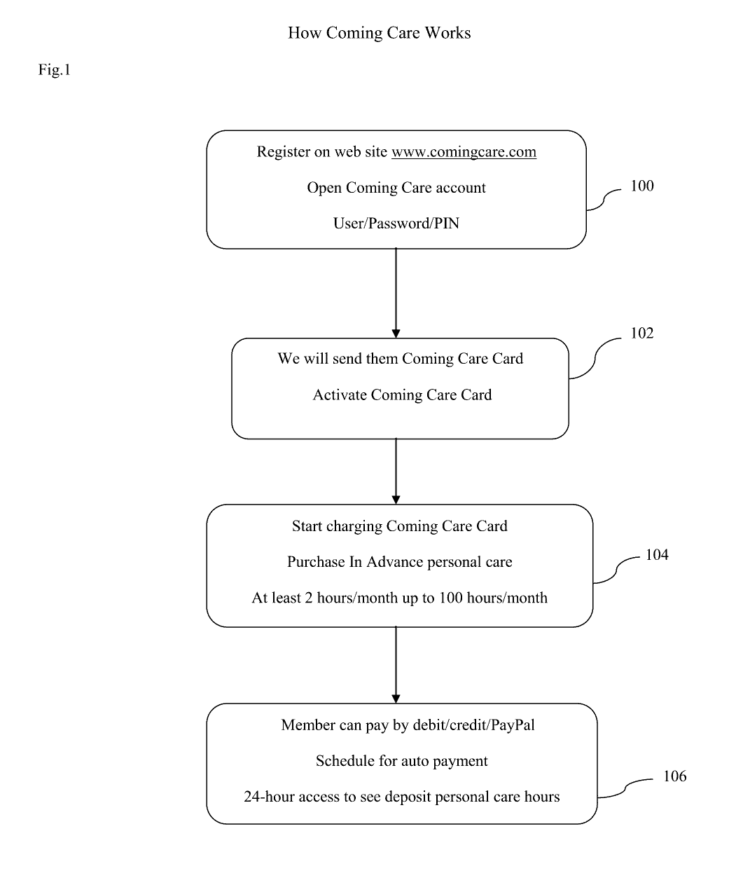

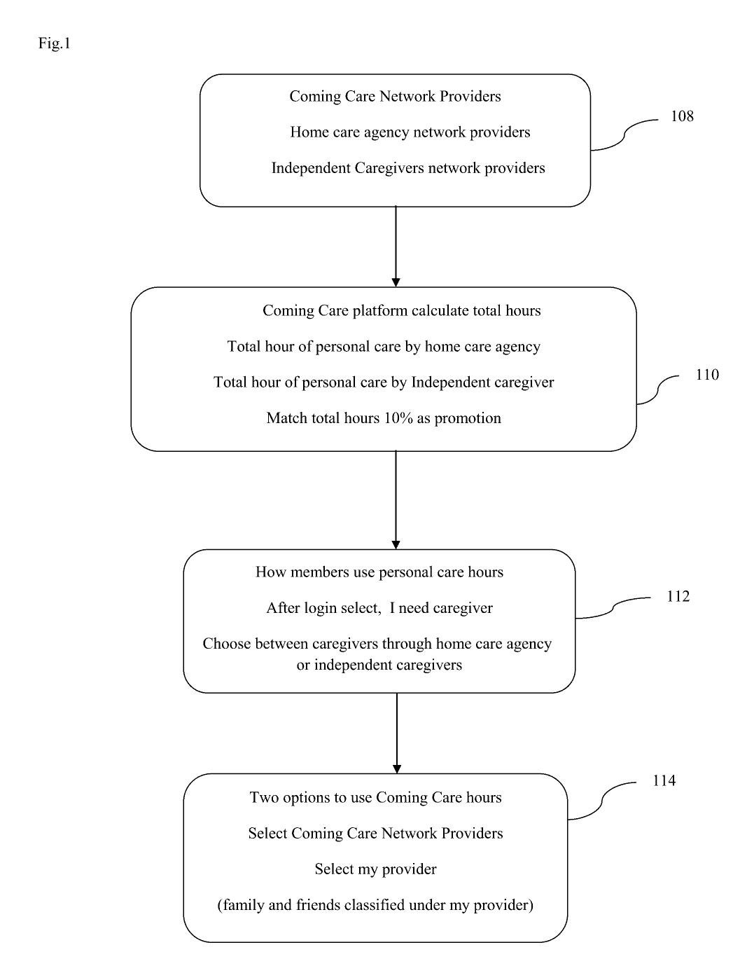

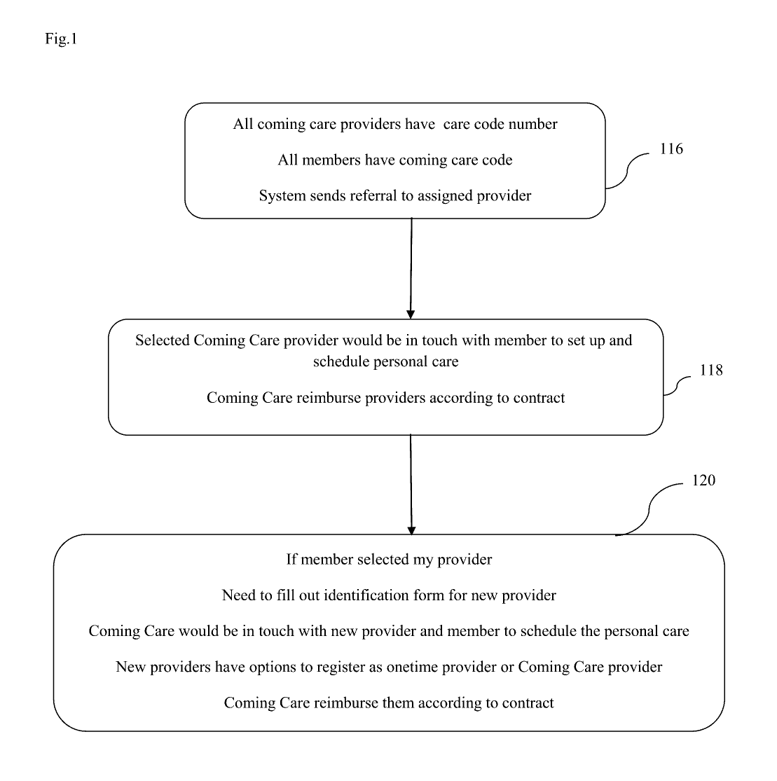

How Coming Care works? As soon as customers made a decision to purchase in advance of personal care hours to use it in the future when they need help for personal care (ADL & IADL) can register through the Coming Care website or app and open an account with user/password/PIN, as showed in diagram FIG. 1/Page. 1 (100). After accept term and condition and set up coming care account, they will receive coming care card (CCC) by mail that should activate through web or app (102). After CCC become active, they can start charging CCC by in advance purchase of personal care hours and pay by credit/debit card (104, 106). There is also option to choose a plan to purchase selected hours and auto payment. The members always have access to check balance hours in their accounts. The coming care platform shows the balance hours in two forms, personal care hours through home care agency and personal care hours through independent caregivers (108, 110).

When the members need to use personal care hours, after login and select I need caregiver, choose between two options, caregivers through home care agency or independent caregivers (112). Then choose between Coming Care Network Providers or my provider (114). If member chose Coming Care Network Providers, Coming Care platform sends referral to assigned provider (116). The selected provider would be in touch with member to schedule personal care services (118). Coming care reimburse providers according to contract. If member chose my provider (family and friends caregivers classified under my provider), they should fill out identification form for new provider then coming care staff would be in touch with new provider and member to schedule personal care services (120). New providers have option to provide personal care services for our members as a onetime provider or register in our network provider.

Coming Care as a management care go through contract with homecare agencies and also private independent caregivers. Members can use Coming Care providers network in each area or select their agency or independent caregivers or even their family and friends, and register them on Coming Care platform. Coming Care platform assign provider Care Code, Caregiver Care Code, and member or beneficiary Care Code to home care agencies, independent caregivers, and Coming Care members respectively. Member must have confirmed use of personal care services from agency or independent caregivers or family and friends before Coming Care pay to providers or independent caregivers or family and friends who did caregiving.

Coming Care has a secret sauce formula for financial sustainability of this model of business that sell in advance personal care hours.

What is claimed is:

1. A new model of business to sell in advance of personal care services (hours) or caregiving services (hours) or non-skilled care services (hours) or ADL and IADL services (hours), and guarantee providing these services (hours) whenever customers need at the same purchased price.

2. The method of claim 1, wherein said sell in advance of personal care services or hours.

3. The method of claim 1, wherein said sell in advance of caregiving services or hours.

4. The method of claim 1, wherein said sell in advance of non-skilled care services or hours.

5. The method of claim 1, wherein said guarantee providing these services (hours) whenever customers need at the same purchased price.

6. This model of business which named Coming Care compromising following steps:
Opening Coming Care account online and set up user, password, and PIN number,
receiving Coming Care Card (CCC) by mail and activate it to purchase in advance of personal care hours,
members always have access to check balance hours in their accounts in two forms, personal care hours through home care agency and personal care hours through independent caregivers or family and friends,
Coming care reimburse personal care providers (home care agency or independent caregivers or family and friends) according to contract,
personal care hours are transferable from one account to another account,
members can request for Coming Care gift cards to donate personal care hours to others (family, friends, or poor people who need care),
Coming Care platform assign Coming Care Code to all care providers, independent caregivers, and members,
Coming Care members when need personal care have options to use IN-Network care providers or OUT-Network care providers or family and friends for caregiving services,
both member and care provider must confirm delivery of personal care before reimbursement.

7. Coming Care invention is directed to a method of creating secured future jobs (caregiving jobs) by changing money to personal care hours and deposit in member accounts, because there is no uncertainty for future use of personal care services and ultimate delivery of personal care will happen.

8. Coming care model of business is directed to a method that has tax benefit for members, with in advance purchase of personal care hours and deposit hours instead of money in account (When you save or invest money you have to pay tax on your earning, but changing money to personal care hours and deposit hours, let you save on tax).

9. Coming Care invention is directed to a method that reimburse care providers according to the contract or transfer of personal care hours to the account of family or friends who take care of members as a caregiver, and this model of business will solve the issue with unpaid family caregiving.

10. Coming care invention is directed to a method that sell in advance personal care hours or caregiving hours and deposit hours in an account, and these hours are transferable and never expire, personal care hours can transfer like funds from one account to another account, just like transfer funds in banking system.

11. Coming Care model of business is directed to a method that issue Coming Care Card (CCC) for all members that act like a debit card for them to use their deposit hours.

12. Coming Care model of business directed to a method that with compare of time value of money, compounding inflation rate, and increase of minimal wage in the last hundred years has showed it's more conscious to buy personal care hours or caregiving services in advance to use in the future in compare with saving money to buy personal care hours in the future.
